(19) United States
(12) Patent Application Publication
(10) Pub. No.: US 2014/0279693 A1
(43) Pub. Date: Sep. 18, 2014

(54) Goal-Based Portfolio Management System

(71) Applicant: Jemstep, Inc., Aventura, FL (US)

(72) Inventors: Simon Roy, Los Altos, CA (US); Clifford Jurie Schoeman, Bryanston (SA); Matthew Rennie, Los Altos (CA); Daniel Lionel Saksenberg, Greenside (SA)

(73) Assignee: Jemstep, Inc., Aventura, FL (US)

(21) Appl. No.: 14/208,588

(22) Filed: Mar. 13, 2014

Related U.S. Application Data
(60) Provisional application No. 61/784,960, filed on Mar. 14, 2013.

(51) Int. Cl. G06Q 40/06

(52) U.S. Cl. CPC G06Q 40/06
USPC 705/36 R

(57) ABSTRACT

A method for providing goal-based portfolio management with a server is provided. User input is received at the server. The user input includes investment goals and portfolio information. An asset allocation and investment strategy based on the received user input is automatically determined with the server by assigning the user to a target portfolio asset allocation, a glide path, and a set of specific recommendations. The glide path is dependent upon at least one of the investment goals received from the user. The glide path includes at least one shift from a first portfolio to a second portfolio different from the first portfolio as a user encounters risk exposure changes while moving towards at least one of the investment goals. The asset allocation and investment strategy are provided from the server to a user interface of the user.

### CROSS-REFERENCE TO RELATED APPLICATIONS

This application claims priority to U.S. Provisional Application Ser. No. 61/784,960, filed on Mar. 14, 2013, the entire disclosure of which is hereby incorporated herein by reference in its entirety.

### STATEMENT REGARDING FEDERALLY SPONSORED RESEARCH OR DEVELOPMENT

Not Applicable

### FIELD OF THE INVENTION

The present invention lies in the field of financial services systems. The present disclosure relates to systems and methods for providing portfolio management, in particular automated portfolio management with computer systems.

### BACKGROUND OF THE INVENTION

Asset allocation is an investment strategy that aims to balance risk and reward by spreading investments across three main asset classes—equities, bonds, and cash—in accordance with an individual's goals, risk tolerance, and investment horizon. Historically, different asset classes have varying degrees of risk and return and therefore behave differently over time. In addition, there are a multitude of different securities—stocks, bonds, mutual funds, exchange traded funds, and the like—that are available to investors in each asset class. Each of these may perform differently; have different fees and other attributes or characteristics that could affect a user's investment outcomes. Taxation is another factor that could have a major impact on investor outcomes, including capital gains or losses and asset location (meaning whether an investment is held in a tax-free, tax-advantaged, or taxable account).

There is presently no automated system for or method of implementing an asset allocation investment strategy that is personalized for a specific user and that (i) incorporates all the user's investment accounts irrespective of where they are housed, (ii) automatically transitions the user to different allocations as the user's circumstances change or the user moves closer toward one or more stated goals (referred to as “glide path”), (iii) gives the user the specific recommendations of which securities to buy, sell, or hold in each of the user's accounts in order to, initially, transition from the user's current asset allocation to the recommended asset allocation, and then to transition through the glide path, taking into account a multitude of factors including fund quality, fees, taxation, and other factors, (iv) continues to monitor the user's portfolio and gives the user the specific buy and sell recommendations to maintain the user's portfolio on track with the recommended asset allocation as certain asset classes become overweight or underweight due to market fluctuations.

Thus, a need exists to overcome the problems with the prior art systems, designs, and processes as discussed above.

### SUMMARY OF THE INVENTION

The invention provides systems and methods for providing portfolio management that overcomes the hereinafore-mentioned disadvantages of the heretofore-known devices and methods of this general type and that provide such features with goal-based portfolio management.

With the foregoing and other objects in view, there is provided, in accordance with the invention, a method for providing goal-based portfolio management with a server. User input is received at the server. The user input includes investment goals and portfolio information. An asset allocation and investment strategy based on the received user input is automatically determined with the server by assigning the user to a target portfolio asset allocation, a glide path, and a set of specific recommendations. The glide path is dependent upon at least one of the investment goals received from the user. The glide path includes at least one shift from a first portfolio to a second portfolio different from the first portfolio as a user encounters risk exposure changes while moving towards at least one of the investment goals. The set of specific recommendations include which securities to buy, sell, or hold in each account of the user in order to, initially, transition from a current asset allocation of the user to a recommended asset allocation for the user, and then to transition through the glide path, taking into account a plurality of factors including at least one of fund quality, fees, and taxation. The asset allocation and investment strategy are provided from the server to a user interface of the user.

In accordance with another mode of the invention, the user input includes at least one of: timing user input selected from at least one of the group consisting of age, retirement age, and life expectancy; financial user input selected from at least one of the group consisting of current earnings, savings, assets, income, Social Security information, and actual holdings; stated risk preference; and spousal information.

In accordance with a further mode of the invention, the spousal information is incorporated and the spousal information is modeled with the user input to provide a combined analysis.

In accordance with an added mode of the invention, in each of the first and second portfolios a tax status of accounts in which investments are held is considered to create an overall portfolio optimized for a user's specific mix of accounts including at least one of taxable accounts, tax advantaged accounts, and tax-free accounts.

In accordance with an additional mode of the invention, the set of specific recommendations include a set of future projections of returns by asset class.

In accordance with yet another mode of the invention, the set of future projections is applied automatically to the first portfolio and/or the second portfolio.

In accordance with yet a further mode of the invention, other portfolios are automatically recommended as user input changes.

In accordance with yet an added mode of the invention, the target portfolio asset allocation is classified according to models. The models include growth, income, conservative, moderate, aggressive, strategic allocation, and tactical allocation.

With the objects of the invention in view, there is also provided a method for providing goal-based portfolio management with a server. User input is received at the server. The user input includes investment goals and portfolio information. An asset allocation and investment strategy based on the received user input is automatically determined with the server by assigning the user to a target portfolio asset allocation, a glide path, and a set of specific recommendations. The glide path is dependent upon at least one of the investment goals received from the user. The glide path includes at least one shift from a first portfolio to a second portfolio different from the first portfolio as a user encounters risk exposure changes while moving towards at least one of the investment goals. The set of specific recommendations include which securities to buy, sell, or hold in each account of the user in order to, initially, transition from a current asset allocation of the user to a recommended asset allocation for the user, and then to transition through the glide path, taking into account a plurality of factors including at least one of fund quality, fees, and taxation. Real-time adjustments of the target portfolio asset allocation and/or glide path are provided or allowed for as the user input changes over time. The asset allocation and investment strategy are provided from the server to a user interface of the user.

With the objects of the invention in view, there is further provided a method for providing goal-based portfolio management with a server. User input is received at the server. The user input includes investment goals and portfolio information. One or more investment accounts of the user are linked. The user's current holdings and current asset allocation in the one or more investment accounts are analyzed. An asset allocation and investment strategy based on the received user input is automatically determined with the server by assigning the user to a target portfolio asset allocation, a glide path, and a set of specific recommendations. The glide path is dependent upon at least one of the investment goals received from the user. The glide path includes at least one shift from a first portfolio to a second portfolio different from the first portfolio as a user encounters risk exposure changes while moving towards at least one of the investment goals. The set of specific recommendations include which securities to buy, sell, or hold in each account of the user in order to, initially, transition from a current asset allocation of the user to a recommended asset allocation for the user, and then to transition through the glide path, taking into account a plurality of factors including at least one of fund quality, fees, and taxation. The asset allocation and investment strategy are provided from the server to a user interface of the user.

In accordance with another mode of the invention, the user input includes at least one of: timing user input selected from at least one of the group consisting of age, retirement age, and life expectancy; financial user input selected from at least one of the group consisting of current earnings, savings, assets, income, Social Security information, and actual holdings; stated risk preference; and spousal information.

In accordance with a further mode of the invention, spousal information is incorporated. The spousal information is modeled with the user input to provide a combined analysis.

In accordance with an added mode of the invention, in the each of the first and second portfolios, a tax status of the accounts in which investments are held is considered to create an overall portfolio optimized for a user's specific mix of accounts including at least one of taxable accounts, tax advantaged accounts, and tax-free accounts.

In accordance with an additional mode of the invention, the set of specific recommendations include a set of future projections of returns by asset class.

In accordance with yet another mode of the invention, the set of future projections is applied automatically to the first portfolio and/or the second portfolio.

In accordance with yet a further mode of the invention, other portfolios are automatically recommended as user input changes.

In accordance with yet an added mode of the invention, the target portfolio asset allocation is classified according to models.

In accordance with yet an additional mode of the invention, the models include growth, income, conservative, moderate, aggressive, strategic allocation, and/or tactical allocation.

In accordance with again another mode of the invention, a rules engine is used to automatically assign specific investments of the user's linked investment accounts to asset classes to model the specific investments.

In accordance with a concomitant mode of the invention, an asset and liability model is used to project income from the user's current asset allocation and the target portfolio asset allocation.

Although the invention is illustrated and described herein as embodied in systems and methods for providing portfolio management, it is, nevertheless, not intended to be limited to the details shown because various modifications and structural changes may be made therein without departing from the spirit of the invention and within the scope and range of equivalents of the claims. Additionally, well-known elements of exemplary embodiments of the invention will not be described in detail or will be omitted so as not to obscure the relevant details of the invention.

Additional advantages and other features characteristic of the present invention will be set forth in the detailed description that follows and may be apparent from the detailed description or may be learned by practice of exemplary embodiments of the invention. Still other advantages of the invention may be realized by any of the instrumentalities, methods, or combinations particularly pointed out in the claims.

Other features that are considered as characteristic for the invention are set forth in the appended claims. As required, detailed embodiments of the present invention are disclosed herein; however, it is to be understood that the disclosed embodiments are merely exemplary of the invention, which can be embodied in various forms. Therefore, specific structural and functional details disclosed herein are not to be interpreted as limiting, but merely as a basis for the claims and as a representative basis for teaching one of ordinary skill in the art to variously employ the present invention in virtually any appropriately detailed structure. Further, the terms and phrases used herein are not intended to be limiting; but rather, to provide an understandable description of the invention. While the specification concludes with claims defining the features of the invention that are regarded as novel, it is believed that the invention will be better understood from a consideration of the following description in conjunction with the drawing figures, in which like reference numerals are carried forward.

### BRIEF DESCRIPTION OF THE DRAWINGS

The accompanying figures, where like reference numerals refer to identical or functionally similar elements throughout the separate views, which are not true to scale, and which, together with the detailed description below, are incorporated in and form part of the specification, serve to illustrate further various embodiments and to explain various principles and advantages all in accordance with the present invention. Advantages of embodiments of the present invention will be apparent from the following detailed description of the exemplary embodiments thereof, which description should be considered in conjunction with the accompanying drawings in which:

FIG. 1 is a diagrammatic representation of a networked system of data processing components in which the present invention may be implemented;

FIG. 2 is a flow diagram of a method for providing goal-based portfolio management in accordance with an exemplary embodiment of the present invention;

FIG. 3 is a block circuit diagram of a data processing system that may be implemented as a server computer system in accordance with an exemplary embodiment of the present invention; and

FIG. 4 is a block circuit diagram of a data processing system that may be implemented as a client computer system in accordance with an exemplary embodiment of the present invention.

### DETAILED DESCRIPTION OF THE INVENTION

As required, detailed embodiments of the present invention are disclosed herein; however, it is to be understood that the disclosed embodiments are merely exemplary of the invention, which can be embodied in various forms. Therefore, specific structural and functional details disclosed herein are not to be interpreted as limiting, but merely as a basis for the claims and as a representative basis for teaching one skilled in the art to variously employ the present invention in virtually any appropriately detailed structure. Further, the terms and phrases used herein are not intended to be limiting; but rather, to provide an understandable description of the invention. While the specification concludes with claims defining the features of the invention that are regarded as novel, it is believed that the invention will be better understood from a consideration of the following description in conjunction with the drawing figures, in which like reference numerals are carried forward.

Alternate embodiments may be devised without departing from the spirit or the scope of the invention. Additionally, well-known elements of exemplary embodiments of the invention will not be described in detail or will be omitted so as not to obscure the relevant details of the invention.

Before the present invention is disclosed and described, it is to be understood that the terminology used herein is for the purpose of describing particular embodiments only and is not intended to be limiting. The terms “a” or “an”, as used herein, are defined as one or more than one. The term “plurality,” as used herein, is defined as two or more than two. The term “another,” as used herein, is defined as at least a second or more. The terms “including” and/or “having,” as used herein, are defined as comprising (i.e., open language). The term “coupled,” as used herein, is defined as connected, although not necessarily directly, and not necessarily mechanically.

Relational terms such as first and second, top and bottom, and the like may be used solely to distinguish one entity or action from another entity or action without necessarily requiring or implying any actual such relationship or order between such entities or actions. The terms “comprises,” “comprising,” or any other variation thereof are intended to cover a non-exclusive inclusion, such that a process, method, article, or apparatus that comprises a list of elements does not include only those elements but may include other elements not expressly listed or inherent to such process, method, article, or apparatus. An element proceeded by “comprises . . . a” does not, without more constraints, preclude the existence of additional identical elements in the process, method, article, or apparatus that comprises the element.

As used herein, the term “about” or “approximately” applies to all numeric values, whether or not explicitly indicated. These terms generally refer to a range of numbers that one of skill in the art would consider equivalent to the recited values (i.e., having the same function or result). In many instances these terms may include numbers that are rounded to the nearest significant figure.

It will be appreciated that embodiments of the invention described herein may be comprised of one or more conventional processors and unique stored program instructions that control the one or more processors to implement, in conjunction with certain non-processor circuits and other elements, some, most, or all of the functions of the powered injector devices described herein. The non-processor circuits may include, but are not limited to, signal drivers, clock circuits, power source circuits, and user input and output elements. Alternatively, some or all functions could be implemented by a state machine that has no stored program instructions, or in one or more application specific integrated circuits (ASICs) or field-programmable gate arrays (FPGA), in which each function or some combinations of certain of the functions are implemented as custom logic. Of course, a combination of these approaches could also be used. Thus, methods and means for these functions have been described herein.

The terms “program,” “software,” “software application,” and the like as used herein, are defined as a sequence of instructions designed for execution on a computer system. A “program,” “software,” “application,” “computer program,” or “software application” may include a subroutine, a function, a procedure, an object method, an object implementation, an executable application, an applet, a servlet, a source code, an object code, a shared library/dynamic load library and/or other sequence of instructions designed for execution on a computer system.

Herein various embodiments of the present invention are described. In many of the different embodiments, features are similar. Therefore, to avoid redundancy, repetitive description of these similar features may not be made in some circumstances. It shall be understood, however, that description of a first-appearing feature applies to the later described similar feature and each respective description, therefore, is to be incorporated therein without such repetition.

The system allows for automated goal-based portfolio management. A user of the system provides certain inputs and information. Based on these inputs, an ideal asset allocation is recommended automatically for the user. The system provides an automated comprehensive analysis of all account types, e.g., 401k, brokerage, IRA, etc. The system automatically decides what holdings to sell and buy to transition the user to a target allocation while reducing any additional portfolio risks and inappropriate holdings. The system also automatically provides specific suggestions of what to buy, sell, or hold. These suggestions consider tax, fees, fund quality, and ranking elements of an underlying ranking engine. The system automatically monitors and rebalances the target asset allocation on an ongoing basis.

The system also adds another layer to define a fund within an asset class that is in a portfolio made up of many asset classes. The system automatically provides awareness of the asset classes within the portfolio instead of focusing only on individual funds. This system automatically evaluates an entire asset allocation for a user's wealth management plan and recommends funds to fill each basket of allocations.

Described now are exemplary embodiments of the present invention. With reference now to the figures, FIG. 1 is a pictorial representation of a networked system 100 of data processing components in which the present invention may be implemented. The system 100 includes a network 102, which is the medium used to provide communications links between various devices and computers connected together within the networked data processing system 100. The network 102 provides communication between a plurality of user computers 104a to 104n and a plurality of information servers 106a to 106n. User computers 104a to 104n can be a desktop, laptop, tablet, smart phone, personal digital assistant, or any other wired or wireless computing device. The network 102 is, for example, the Internet and provides on-line services. The network servers 106a to 106n manage network traffic such as the communications between any given user's computer 104 and an information server 106. The network 102 may include wired or wireless connections. A few exemplary wired connections are cable, phone line, and fiber optic. Exemplary wireless connections include radio frequency (RF) and infrared radiation (IR) transmission. Many other wired and wireless connections are known in the art and can be used with the present invention.

The user computers 104 are equipped with communications software, including a World Wide Web (WWW) browser that allows a searcher to connect and use on-line searching services through the Internet. The software or application on a user computer 104 manages the display of information received from the servers 106 to the user computer 104 and communicates user's actions back to the appropriate information servers 106 so that additional display information may be presented to the user or the information acted on.

In the depicted example of FIG. 1, servers 106a-n are connected to network 102 along with storage units 108a-n. The storage units 108a-n hold data and are searchable by and accessible to the servers 106a-n through the network 102. As an alternative, one or more of the storage units 108a-n may be coupled directly to one of the servers 106a-n, by, for instance, a link 111.

The system 100 also includes a plurality of search servers 110a-n provided by search service providers that maintain full text indexes 112 of information maintained by servers 106a-n obtained by interrogating databases 114. Some of these search service providers are general purpose search providers while others are topic specific search providers.

Network data processing system 100 may include additional servers, clients, and other devices not shown. In the depicted example, network data processing system 100 includes the Internet with network 102 representing a worldwide collection of networks and gateways that use the TCP/IP suite of protocols to communicate with one another. At the heart of the Internet is a backbone of high-speed data communication lines between major nodes or host computers, consisting of thousands of commercial, government, educational, and other computer systems that route data and messages. Of course, network data processing system 100 also may be implemented as a number of different types of networks, such as for example, an intranet, a local area network (LAN), or a wide area network (WAN). FIG. 1 is intended as an example, and not as an architectural limitation for the present invention.

The present system provides goal-based portfolio management. Users select an investment goal and the system provides investment recommendations to help users move to the investment portfolio that is most ideally suited to achieving their goals. Some examples of goals for investments are retirement, college, and wealth building.

FIG. 2 illustrates a flow diagram of a method for providing goal-based portfolio management. Method 200 begins at item 205. At item 210, a target allocation and glide path is generated. Information such as user profile information 215 and user profile information 220 can be input for consideration at item 210. User input may be entered at computer 104a-n and transmitted to server 106a-n over network 102. Server 106a-n can be used to gather user portfolio data 220. Alternatively, a user can manually input portfolio data at computer 104a-n. At item 225, buys, sells, and/or holds are generated. The generation of buys/sells/holds is based on an analysis and rank of a plurality of securities. At item 235, a target outcome versus a current outcome is projected. At item 240, an objective function is applied. At item 245, a determination is made as to whether an optimal solution has been found. If an optimal solution has been found, an action plan is presented to the user at item 250. If an optimal solution has not been found, adjustments are applied at item 255, and the method returns to item 210, where a subsequent target allocation and glide path is generated. The user is assigned to a target portfolio asset allocation and glide path according to one or more goals defined by the user as described herein.

Selecting Allocation and Glide Path

The system selects an allocation and glide path for a user. The user is requested by the system to provide certain inputs and information, for example, in a user profile. Based on the user provided input, the system recommends an ideal asset allocation for the user. Given what a user has currently invested and the user's goal(s), the system determines whether the user is on track to reach the stated goal(s) and guides the user to an ideal asset allocation that best fits the user's goal(s). Some examples of user profile inputs are timing, financial, and stated risk preference. Examples of timing include age, retirement age, and life expectancy. Examples of financial user input include current earnings, savings, assets, income, Social Security information, and actual holdings.

In one embodiment, the system allows the user to add information about his/her spouse. The system then incorporates the information of the spouse and models this information in conjunction with the user's information to run combined analysis.

The system has a set of portfolios (asset allocations) that are guided or recommended to the user, e.g., target portfolios. The system utilizes a set of future projections of returns by asset class. The set of future projections can be referred to as stochastic blocks. The set of future projections can be applied automatically to a target portfolio and/or a current portfolio of a user. In this way, an automated “apples-to-apples” comparison can be done between the projected performance of a target portfolio versus the projected performance of the user's current portfolio. The system can show a user automatically what their current portfolio is on track to yield and what the user can expect to yield if the user moves to the target portfolio. The system is also able to provide portfolio statistics automatically. In addition, as inputs change, other target portfolios can be recommended automatically by the system. The target portfolios can be classified according to certain models, for example, growth, income, conservative, moderate, aggressive, strategic allocation, and tactical allocation. An initial target portfolio is recommended by the system. Thereafter, the system automatically guides the user to other target portfolios as the user's circumstances change and/or the user moves closer to retirement. This is referred to as herein as a glide path. The system also allows a user to select a model portfolio recommended by a ranking engine, and/or to modify the recommended or other model portfolios to reflect their own preferences.

The user can link his/her investment accounts to the system. Once the accounts are linked to the system, an asset class translation is performed. The system analyzes the user's current holdings and asset allocation. A rules engine is used to assign specific investments to asset classes automatically so that the specific investments can be modeled. Rules can also be set to handle unrecognized holdings.

In one exemplary embodiment, a smart matching technology is used to automatically match the specific investments to asset classes. The system determines projections of earnings that a user should expect to receive given the user's current portfolio. For example, if a user presently has a 50-50 portfolio (50% bonds and 50% stocks), the system can automatically compare that portfolio to a 60-40 portfolio suggested to the user by the system. The system can determine projected earnings based on the current portfolio and the suggested portfolio.

Based on user provided input and information, the system automatically assigns the user to a target portfolio asset allocation and glide path. Assignment of the portfolio and glide path is done to best achieve the user's goal(s), e.g., retirement, college, house purchase, wealth building. The system starts with an initial portfolio asset allocation. A glide path is defined automatically as a shift from one portfolio to another as a user appropriates or encounters risk exposure changes, for example, as the user moves closer to retirement and end of life. For example, the system may change to lower risk portfolios as a user ages. When the system recommends buys and sells (of the investments), the portfolios consider the tax status of the accounts in which investments are held in order to create an allocation optimized for a user's specific mix of taxable, tax advantaged, and/or tax-free accounts.

The system uses an asset and liability model to project income from a user's current portfolio and a target portfolio. This asset and liability model takes into account: current assets, increases in assets, a projection of sustainable expenditure in retirement, and calculates the recommended asset allocation for the user and the required asset class buys and sells to transition to and maintain the recommended asset allocation.

Current assets are taken into account to project income and growth from a current portfolio and a target portfolio. Current assets can be provided by a user manually inputting present holdings or using automated account aggregation services or through some form of direct connection with their brokerage accounts.

Increases in assets are taken into account automatically. Projected increases in assets can be embodied in investment returns using stochastic blocks or a Monte Carlo model and portfolios. The increases in assets can also be from future savings, future income and growth, and future assets. Future income can be Social Security income, rental income, or any other income stream. Future assets can also be embodied in a future value of a home, business, inheritance, etc.

The system can automatically project a sustainable expenditure in retirement. The system presents the information in a way that is understandable for users. For example, the system allows the user to see how much projected income/expenditure the user will have in retirement with the recommended allocation as compared to how much income/expenditure the user will have with a current allocation. Using the present system, a user can pick a yearly withdrawal percentage, e.g., 4% or a target expenditure in retirement to model current versus recommended portfolio, and determine based on that withdrawal rate whether there is a chance that the user will run out of money while in retirement. The system can modify the current and target portfolio returns automatically based on fund fees, management fees, risk characteristics, performance of specific holdings, etc. The system can present outcomes automatically to reflect different market conditions.

Portfolio statistics can also be provided to a user automatically. These statistics may include risk, return, and the probability of running out of money during retirement. Statistics for annual assets before and after retirement may be provided automatically. Information on the impact of bad market conditions on the portfolio and other statistics may also be provided automatically.

The system provides and illustrates for a user the difference between outcomes for a current portfolio and a target portfolio. Virtual levers can be provided on a graphical user interface (GUI) for a user to modify inputs in order for the user to see the impact of changes in the inputs. For example, the user can use these virtual levers to determine how changes in the inputs improve outcomes for current and target portfolio returns. Examples of input changes include the user saving more, retiring later, changing portfolio risk, and/or changing life expectancy.

The system allows for real-time adjustments as inputs change over time. A portfolio value may change due to allocation changes. A user profile may change due to the age or marital status of the user.

The system can also project a sustainable expenditure in retirement by calculating the recommended asset allocation for the user and the required asset class buys and sells to transition to and maintain the recommended asset allocation. The asset class sells and buys are calculated in an amount of dollars and percentage in order to move to the target allocation.

Fund Selection (Action Plan)/Execution

The system automatically presents an action plan detailing what securities the user must sell, buy, or hold in each of the user's accounts in order to reach the target allocation. Some of these recommended buys and sell are unrelated to the asset allocation per se but reflect on the overall quality of the investments, as described below with respect to the coarse evaluation. The present system is not limited to providing generic scores/recommendations. This system is capable of providing information specifically tailored to the user and based upon user selections and desires. This automated system can give very tailored and user-specific results to determine a fully balanced portfolio for the user. The system automatically decides what holdings to sell and buy to transition the user to the target allocation while reducing any additional portfolio risks and inappropriate holdings, e.g., concentrated positions, bad fit funds, excessive fees, etc.

The system automatically provides an overall portfolio construction that determines the types of funds preferred by the user/investor and uses these preferences as an input to the fund buy and sell selection process. The preferences can be based on user input or system default settings. The user input or defaults can be used to classify the user as an active or passive investor, or a combination of both. The user is able to set a preference for mutual funds, Exchange Traded Funds, or individual stocks or bonds. Time horizons can be set from a user's age inputs. A stated risk preference can also be used as input. Lastly, additional default settings can be used as input to the system. Additional default settings can be implicit or explicit factors like the need for a certain level of income or the ability to absorb risk.

The system uses a richer set of inputs in order to rank investment holdings accordingly. For example, a current fund (singular) can be evaluated to determine if that fund or another fund is a best fit for a user based on the user's input/preference data.

The system evaluates funds automatically according to certain criteria and/or processes. The criteria or process can be a coarse evaluation or a fine evaluation.

The coarse evaluation can be likened to a quick portfolio hygiene check. For the coarse evaluation, global sells are identified. Global sells are holdings that should be sold irrespective of asset allocation changes. Global sells can be initiated automatically for bad fit funds, mixed asset class funds, concentrated holdings, asset location mismatches, or other types of funds capable of being classified as a global sell according to system criteria. The system can also incorporate discreet strategies such as tax-loss harvesting and dollar-cost averaging its buy and sell recommendations. An example of a mixed asset class fund can be a target date fund. An example of an asset location mismatch can be municipal bonds in tax-advantaged accounts.

The output of the coarse evaluation criteria/process is a new asset allocation with some free cash that is used to determine what additional sells need to be made in order to reduce overweight asset class holdings to an appropriate level.

For the fine evaluation as it relates to overweight asset classes, the system automatically determines which current holdings should be sold in which accounts to reduce overweight asset classes to the target levels. The evaluation includes non-fund holdings such as individual stocks and bonds as potential sales targets.

In one embodiment, the system automatically ranks the funds. Based on the system ranking, the system would automatically sell the lowest ranked funds, if set to do so.

The present system can also take into account additional factors. The system can automatically identify a cost basis and potential capital gains or losses in order to minimize tax costs. In this case, the system would sell the holding(s) with losses. Another factor is a correlation to the asset class index, where the closer the fund is to the index, the better.

Asset location is another factor. When asset location is taken into account, the system tends to sell holdings that are in the “wrong” account type relative to other holdings. There are three account types: taxable; tax-deferred; and tax-free. The system analyzes the user's account and determines mismatches. The system automatically factors in which account the investment resides and sells when the investment is in the wrong account.

Present and future sector balance or style balance can be factors. Examples of sector balance include, but are not limited to, real estate, finance, energy, etc. Examples of style balance, include but are not limited to, growth, value, and balanced.

Another factor that can be taken into account is whether or not a user prefers an active versus a passive investment. For example, if a user's preference is passive investments, active funds are sold first. A user's preference for mutual funds versus Exchange Traded Funds (ETFs) can also be a factor. Other factors may be considered depending on the circumstances.

For the fine evaluation as it relates to underweight asset classes, the system automatically determines how much to buy in each asset class. When determining how much to buy, the system evaluates how much available cash is in each account.

The asset class buys can be sequenced so that the system purchases first in the least tax efficient asset classes (income producing) and works through to the most tax efficient (tax-free, then taxable). In this way, the asset class buys or the asset location of the buys are optimized automatically to be more closely aligned with an optimal asset location. The system automatically factors in with every sell/buy which is the best account to buy and which is the worst account to sell. The system can also operate in reverse order if appropriate.

The system begins automatically purchasing the first asset class in the most appropriate account for that asset class. If all purchases of that asset class cannot be made in that account, the system cycles to the next most appropriate account for that asset class until all purchases in that asset class are complete. The system then proceeds to the next asset class, and proceeds on the same basis until all asset class buys are complete. The goal is to ensure that purchases move the investors as close as possible to the stated asset location optima.

In one exemplary embodiment, the system ranks the funds. Based on the system ranking, the system would automatically buy the highest ranked funds.

The fund evaluation criteria can be the system ranking for appropriate investment preferences, e.g., ETFs, mutual funds, active, passive, and/or additional inputs or default inputs/preferences. The fund evaluation criteria can also be based on a correlation coefficient or some other relevant criteria.

The user has the option to modify or reject the sell or buy recommendation of a specific fund. For sells, the user may select another current holding in that asset class to sell using the methodology described above, e.g., coarse and/or fine sells.

For buys, the system can offer the user a list of alternative top ranked funds using the methodology described above, e.g., fine buys. The system can provide a “constrained list” of funds available by account that is specific to a broker, 401k plan account type, etc. Users may participate in the creation of the “constrained list.”

In one exemplary embodiment, an overall portfolio score can be determined. A global portfolio objective function can be developed to evaluate a fitness of a new portfolio with respect to an old portfolio. Information used to determine fitness can be, e.g., a total number of transactions, capital gains, etc. An optimizing methodology can be used to provide information on whether the new portfolio can be improved. The scores can be used to inform the user how much better, e.g., in dollars, a percentage, etc., the new portfolio recommended by the system is when compared to the user's incoming portfolio.

If there are constraints on what the user can buy and sell (e.g. 401k, or the user does not want to sell a specific investment), the system automatically re-runs the asset allocation and the income projections/asset liability to incorporate these constraints (external or user driven constraints). After rerunning the asset allocation, the system then automatically generates the action plan to reflect this new asset allocation and the constraints.

In one exemplary embodiment, the system and/or the user may designate certain accounts as “locked.” In other words, no buy or sell recommendations will be given for those accounts, although the recommended asset allocation will still incorporate those holdings for the purpose of analyzing the overall portfolio and asset allocation for the user.

The system is designed to incorporate portfolios optimized for tax advantaged or taxable accounts, or a combination of both.

In one exemplary embodiment, users can execute trades on their broker's website using the system. Trades can be executed using a link to the broker's website. An Application Programming Interface (API) to a broker or through a third party can be used by the system to automatically populate trades for the user to confirm. A user can assign the system to automatically execute trades directly on the investor's website through an API or third party interface. The user can also transfer their account to the system so that the system can manage trades.

When using the optimization methodology to provide overall portfolio scoring, the system generates a “best cut” of the buys and sells in order to meet the user's target allocation. Linear programming optimization is used to evaluate an initial cut against the optimal portfolio level objectives. These competing objectives may include, but are not limited to one or more of the following: minimizing the trading costs in transitioning from the current portfolio to the new portfolio; minimizing the capital gains from the transactions; maximizing the percentage of assets located in the optimal accounts (taxable, tax-deferred, and tax-free); maximizing the average system score of the ranked investments in the portfolio; maximizing the overall percentage ‘compliance’ with the target asset allocation; maximizing the fit to the investor preferences (active/passive, ETFs/mutual funds, etc.); and other system, adviser, or user determined factors. Each of the one or more competing objectives are given weight and included in an ‘objective function’ that enables the optimizer to ‘score’ each potential solution. The optimizer automatically tests additional ‘solutions’ to determine whether there are sets of buys and sells that score better and settles on the most optimal solution, which solution is presented to the user.

Ongoing Monitoring and Rebalancing

The present system allows for ongoing monitoring and rebalancing automatically. A set of rules is devised in order to re-evaluate after one or more investments drifts away from the allocations. The system or the user can set a rebalance timeframe (quarterly, annually) and/or out of target bands in order to trigger a rebalance. The rebalancing mechanism allows the system or user to decide on a set of rules for when the user returns to a target allocation. The system automatically generates a sell and buy list using the previously described criteria and process(es). The system automatically tracks user transactions in order to monitor the movement to the target portfolio. The user is given feedback automatically, e.g., using a GUI, on actions taken and changes in status. The user can be presented with non-asset allocation driven potential sells and buys based on the same criteria as global sells but at a lower level of sensitivity. New money can be allocated to the appropriate underweight asset class at the time of the inflow using the previously described purchase criteria. Money can be withdrawn iteratively from the most underweight asset class to the next asset class until the money withdrawal need is fulfilled.

Server

Referring to FIG. 3, a block diagram of a data processing system that may be implemented as a server, such as server 106 and/or server 110 in FIG. 1, is depicted in accordance with one exemplary embodiment of the present invention. Data processing system 300 may be a symmetric multiprocessor (SMP) system including a plurality of processors 302 and 304 connected to system bus 306. Alternatively, a single processor system may be employed. Also, connected to system bus 306 is memory controller/cache 308, which provides an interface to local memory 309. I/O bus bridge 310 is connected to system bus 306 and provides an interface to I/O bus 312. Memory controller/cache 308 and I/O bus bridge 310 may be integrated as depicted. The processor 302 or 304 in conjunction with memory controller 308 controls what data is stored in memory 309. The processor 302 or 304 can also work in conjunction with any other memory device or storage locations, such as storage areas 108a-n, to serve as a monitor for monitoring data being stored and/or accessed on the data storage areas 108a-n.

Peripheral component interconnect (PCI) bus bridge 314 connected to I/O bus 312 provides an interface to PCI local bus 316. A number of modems may be connected to PCI bus 316. Typical PCI bus implementations will support four PCI expansion slots or add-in connectors. Communications links to network computers 104a-n in FIG. 1 may be provided through modem 318 and network adapter 320 connected to PCI local bus 316 through add-in boards.

Additional PCI bus bridges 322 and 324 provide interfaces for additional PCI buses 326 and 328, from which additional modems or network adapters may be supported. In this manner, data processing system 300 allows connections to multiple network computers. A memory-mapped graphics adapter 330 and hard disk 332 may also be connected to I/O bus 312 as depicted, either directly or indirectly.

Those of ordinary skill in the art will appreciate that the hardware depicted in FIG. 3 may vary. For example, other peripheral devices, such as optical disk drives and the like, also may be used in addition to or in place of the hardware depicted. The depicted example is not meant to imply architectural limitations with respect to the present invention.

In this document, the terms “computer program medium,” “computer usable medium,” and “computer readable medium” are used to generally refer to media such as main memory 309, removable storage drive 331, removable media 333, hard disk 332, and signals. These computer program products are measures for providing software to the computer system. The computer readable medium allows the computer system to read data, instructions, messages or message packets, and other computer readable information from the computer readable medium. The computer readable medium, for example, may include non-volatile memory, such as Floppy, ROM, Flash memory, Disk drive memory, CD-ROM, and other permanent storage. It is useful, for example, for transporting information, such as data and computer instructions, between computer systems. Furthermore, the computer readable medium may include computer readable information in a transitory state medium such as a network link and/or a network interface, including a wired network or a wireless network, that allow a computer to read such computer readable information.

Computer programs (also called computer control logic) are stored in memory. Computer programs may also be received through communications interface 316. Such computer programs, when executed, enable the computer system to perform the features of the present invention as discussed herein. In particular, the computer programs, when executed, enable the processor 302 and/or 304 to perform the features of the computer system. Accordingly, such computer programs represent controllers of the computer system.

Client Device

With reference now to FIG. 4, a block diagram illustrating a data processing system is depicted in which the present invention may be implemented. Data processing system 400 is an example of a client computer 104. Data processing system 400 employs a peripheral component interconnect (PCI) local bus architecture. Although the depicted example employs a PCI bus, other bus architectures such as Accelerated Graphics Port (AGP) and Industry Standard Architecture (ISA) may be used. Processor 402 and main memory 404 are connected to PCI local bus 406 through PCI bridge 408. PCI bridge 408 also may include an integrated memory controller and cache memory for processor 402. Additional connections to PCI local bus 406 may be made through direct component interconnection or through add-in boards. In the depicted example, local area network (LAN) adapter 410, SCSI host bus adapter 412, and expansion bus interface 414 are connected to PCI local bus 406 by direct component connection. In contrast, audio adapter 416, graphics adapter 418, and audio/video adapter 419 are connected to PCI local bus 406 by add-in boards inserted into expansion slots. Expansion bus interface 414 provides a connection for a keyboard and mouse adapter 420, modem 422, and additional memory 424, for example. Small computer system interface (SCSI) host bus adapter 412 provides a connection for hard disk drive 426, tape drive 428, and CD-ROM drive 430, for example. Typical PCI local bus implementations will support three or four PCI expansion slots or add-in connectors.

An operating system runs on processor 402 and is used to coordinate and provide control of various components within data processing system 400 in FIG. 4. Each client is able to execute a different operating system. The operating system may be a commercially available operating system. A database program may run in conjunction with the operating system and provide calls to the operating system from programs or applications executing on data processing system 400. Instructions for the operating system, the object-oriented operating system, and applications or programs are located on storage devices, such as hard disk drive 426, and may be loaded into main memory 404 for execution by processor 402.

Those of ordinary skill in the art will appreciate that the hardware in FIG. 4 may vary depending on the implementation. Other internal hardware or peripheral devices, such as flash ROM (or equivalent nonvolatile memory) or optical disk drives and the like, may be used in addition to or in place of the hardware depicted in FIG. 4. Also, the processes of the present invention may be applied to a multiprocessor data processing system.

As another example, data processing system 400 may be a stand-alone system configured to be bootable without relying on some type of network communication interface, whether or not data processing system 400 includes some type of network communication interface. As a further example, data processing system 400 may be a Personal Digital Assistant (PDA) device, which is configured with ROM and/or flash ROM in order to provide non-volatile memory for storing operating system files and/or user-generated data.

The depicted example in FIG. 4 and above-described examples are not meant to imply architectural limitations. For example, data processing system 400 also may be a notebook computer or hand-held computer in addition to taking the form of a PDA. Data processing system 400 also may be a kiosk or a Web appliance.

It is noted that various individual features of the inventive processes and systems may be described only in one exemplary embodiment herein. The particular choice for description herein with regard to a single exemplary embodiment is not to be taken as a limitation that the particular feature is only applicable to the embodiment in which it is described. All features described herein are equally applicable to, additive, or interchangeable with any or all of the other exemplary embodiments described herein and in any combination or grouping or arrangement. In particular, use of a single reference numeral herein to illustrate, define, or describe a particular feature does not mean that the feature cannot be associated or equated to another feature in another drawing figure or description. Further, where two or more reference numerals are used in the figures or in the drawings, this should not be construed as being limited to only those embodiments or features, they are equally applicable to similar features or not a reference numeral is used or another reference numeral is omitted.

The phrase “at least one of A and B” is used herein and/or in the following claims, where A and B are variables indicating a particular object or attribute. When used, this phrase is intended to and is hereby defined as a choice of A or B or both A and B, which is similar to the phrase “and/or”. Where more than two variables are present in such a phrase, this phrase is hereby defined as including only one of the variables, any one of the variables, any combination of any of the variables, and all of the variables.

The foregoing description and accompanying drawings illustrate the principles, exemplary embodiments, and modes of operation of the invention. However, the invention should not be construed as being limited to the particular embodiments discussed above. Additional variations of the embodiments discussed above will be appreciated by those skilled in the art and the above-described embodiments should be regarded as illustrative rather than restrictive. Accordingly, it should be appreciated that variations to those embodiments can be made by those skilled in the art without departing from the scope of the invention as defined by the following claims.

What is claimed is:

1. A method for providing goal-based portfolio management with a server, which comprises:
receiving user input at the server, the user input comprising investment goals and portfolio information; and
automatically determining with the server an asset allocation and investment strategy based on the received user input by assigning the user to:
a target portfolio asset allocation;
a glide path dependent upon at least one of the investment goals received from the user, the glide path comprising at least one shift from a first portfolio to a second portfolio different from the first portfolio as a user encounters risk exposure changes while moving towards at least one of the investment goals; and
a set of specific recommendations of which securities to buy, sell, or hold in each account of the user in order to, initially, transition from a current asset allocation of the user to a recommended asset allocation for the user, and then to transition through the glide path, taking into account a plurality of factors including at least one of fund quality, fees, and taxation;
providing the asset allocation and investment strategy from the server to a user interface of the user.

2. The method according to claim 1, wherein the user input comprises at least one of:
timing user input selected from at least one of the group consisting of age, retirement age, and life expectancy;
financial user input selected from at least one of the group consisting of current earnings, savings, assets, income, Social Security information, and actual holdings;
stated risk preference; and
spousal information.

3. The method according to claim 2, which further comprises:
incorporating the spousal information; and
modeling the spousal information with the user input to provide a combined analysis.

4. The method according to claim 1, which further comprises considering, in each of the first and second portfolios, a tax status of accounts in which investments are held to create an overall portfolio optimized for a user's specific mix of accounts including at least one of taxable accounts, tax advantaged accounts, and tax-free accounts.

5. The method according to claim 1, wherein the set of specific recommendations comprise a set of future projections of returns by asset class.

6. The method according to claim 5, which further comprises applying the set of future projections automatically to the first portfolio and/or the second portfolio.

7. The method according to claim 1, which further comprises automatically recommending other portfolios as user input changes.

8. The method according to claim 1, which further comprises classifying the target portfolio asset allocation according to models, the models comprising growth, income, conservative, moderate, aggressive, strategic allocation, and tactical allocation.

9. A method for providing goal-based portfolio management with a server, which comprises:
receiving user input at the server, the user input comprising investment goals and portfolio information; and
automatically determining with the server an ideal asset allocation and investment strategy based on the received user input by assigning the user to:
a target portfolio asset allocation;
a glide path dependent upon at least one of the investment goals received from the user, the glide path comprising at least one shift from a first portfolio to a second portfolio different from the first portfolio as a user encounters risk exposure changes while moving towards at least one of the investment goals; and
a set of specific recommendations of which securities to buy, sell, or hold in each account of the user in order to, initially, transition from a current asset allocation of the user to a recommended asset allocation for the user, and then to transition through the glide path, taking into account a plurality of factors including at least one of fund quality, fees, and taxation; and
allowing for real-time adjustments of the target portfolio asset allocation and/or glide path as the user input changes over time;
providing the asset allocation and investment strategy and/or real-time adjustments from the server to a user interface of the user.

10. A method for providing goal-based portfolio management with a server, which comprises:
receiving user input at the server, the user input comprising investment goals and portfolio information;
linking one or more investment accounts of the user;
analyzing the user's current holdings and current asset allocation in the one or more investment accounts; and
automatically determining with the server an ideal asset allocation and investment strategy based on the received user input by assigning the user to:
a target portfolio asset allocation;
a glide path dependent upon at least one of the investment goals received from the user, the glide path comprising at least one shift from a first portfolio to a second portfolio different from the first portfolio as a user encounters risk exposure changes while moving towards at least one of the investment goals; and
a set of specific recommendations of which securities to buy, sell, or hold in each account of the user in order to, initially, transition from a current asset allocation of the user to a recommended asset allocation for the user, and then to transition through the glide path, taking into account a plurality of factors including at least one of fund quality, fees, and taxation;
providing the asset allocation and investment strategy from the server to a user interface of the user.

11. The method according to claim 10, wherein the user input comprises at least one of:
timing user input selected from at least one of the group consisting of age, retirement age, and life expectancy;
financial user input selected from at least one of the group consisting of current earnings, savings, assets, income, Social Security information, and actual holdings;
stated risk preference; and
spousal information.

12. The method according to claim 11, which further comprises:
incorporating the spousal information; and
modeling the spousal information with the user input to provide a combined analysis.

13. The method according to claim 10, which further comprises considering, in the each of the first and second portfolios, a tax status of the accounts in which investments are held to create an overall portfolio optimized for a user's specific mix of accounts including at least one of taxable accounts, tax advantaged accounts, and tax-free accounts.

14. The method according to claim 10, wherein the set of specific recommendations comprise a set of future projections of returns by asset class.

15. The method according to claim 14, which further comprises applying the set of future projections automatically to the first portfolio and/or the second portfolio.

16. The method according to claim 10, which further comprises automatically recommending other portfolios as user input changes.

17. The method according to claim 10, which further comprises classifying the target portfolio asset allocation according to models.

18. The method according to claim 17, wherein the models comprise growth, income, conservative, moderate, aggressive, strategic allocation, and/or tactical allocation.

19. The method according to claim 10, which further comprises using a rules engine to automatically assign specific investments of the user's linked investment accounts to asset classes to model the specific investments.

20. The method according to claim 10, which further comprises using an asset and liability model to project income from the user's current asset allocation and the target portfolio asset allocation.
